(19) United States
(12) Patent Application Publication
(10) Pub. No.: US 2022/0074551 A1
(43) Pub. Date: Mar. 10, 2022

(54) STATION FOR FILLING GAS TANKS

(71) Applicant: L'Air Liquide, Societe Anonyme pour l'Etude et l'Exploitation des Procedes Georges Claude, Paris (FR)

(72) Inventors: David VEMPAIRE, Sassenage (FR); Etienne WERLEN, Sassenage (FR)

(73) Assignee: L'Air Liquide, Societe Anonyme pour l'Etude et l'Exploitation des Procedes Georges Claude, Paris (FR)

(21) Appl. No.: 17/470,850

(22) Filed: Sep. 9, 2021

(30) Foreign Application Priority Data
Sep. 10, 2020 (FR) FR 2009149

(51) Int. Cl. F17C 5/00; F17C 5/02

(52) U.S. Cl. CPC F17C 5/007; F17C 5/02; F17C 2205/0302; F17C 2265/061; F17C 2260/035; F17C 2270/0168; F17C 2221/012

(57) ABSTRACT

Station for filling gas tanks comprising a gas source, a circuit comprising an upstream end connected to the source and a downstream end comprising a hose portion, the end of which is intended to be connected to the tank(s) to be filled, the circuit comprising, between the source and the downstream end, an automatic shut-off breakaway coupling arranged along a working axis, said breakaway coupling ensuring an automatic shut-off of the circuit in case of a determined tensile force on said breakaway coupling along its working axis, the station comprising a dispenser housing, the breakaway coupling being arranged in the dispenser housing with a determined orientation of the working axis, at least one part of the hose portion of the downstream end of the circuit protruding from the dispenser housing, the dispenser housing comprising a guide member for guiding a zone of the hose portion, characterized in that the guide member comprises an assembly deflecting wall(s) converging toward a central passage zone ensuring the localized retention of the hose portion, the portion of circuit located between the breakaway coupling and the guide member being oriented at least substantially along the working axis of the breakaway coupling, the assembly of deflecting wall(s) of the guide member being further configured to transfer, along the working axis of the breakaway coupling, at least part of the tensile forces on the hose portion that are oriented transversely with respect to the working axis of the breakaway coupling.

### CROSS-REFERENCE TO RELATED APPLICATIONS

This application claims the benefit of priority under 35 U.S.C. § 119 (a) and (b) to French patent application No. FR 2009149, filed Sep. 10, 2020, the entire contents of which are incorporated herein by reference.

### BACKGROUND

### Field of the Invention

The invention relates to a gas tank filling station.

The invention relates more particularly to a filling station for gas tanks comprising a gas source, a circuit comprising an upstream end connected to the source and a downstream end comprising a hose portion, the end of which is intended to be connected to the tank(s) to be filled, the circuit comprising, between the source and the downstream end, an automatic shut-off breakaway coupling arranged along a working axis, said breakaway coupling ensuring an automatic shut-off of the circuit in the event of a determined tensile force on said breakaway coupling along its working axis, the station comprising a dispenser housing, the breakaway coupling being arranged in the dispenser housing with a determined orientation of the working axis, at least part of the hose portion of the downstream end of the circuit projecting out of the dispenser housing, the dispenser housing comprising a guide member for guiding a zone of the hose portion.

### Related Art

When filling a gas (or liquid) hydrogen tank of a vehicle, the end nozzle is connected to the vehicle. It is up to the user to remember to disconnect the nozzle at the end of filling. If he forgets and drives off in his vehicle with the nozzle connected, the hose may be torn off and the dispenser damaged.

In order to avoid damage to the hose and the dispenser, a decoupling system is necessary. Many systems exist that use “breakaway” couplings that shut off the circuit if the vehicle is started while the nozzle is still connected. The disconnection is thus automatic, whether the system is under pressure or not. The breakaway couplings are reusable and may be safely reconnected.

The known systems require the tensile force exerted to be on the working axis of the breakaway coupling system (or at a small angle, i.e. between zero and thirty degrees). In known safety systems, the breakaway coupling is integrated into the nozzle.

In another known configuration called “fixed mounting”, the breakaway coupling is usually fixed in a vertical position at a height of 2-3 metres from the ground with a downward hose connection. However, when the nozzle is being pulled off, a large angle relative to the vertical is possible and thus a large angle relative to the axis of the breakaway coupling. This angle is generally greater than 45 degrees. This is outside the optimum operating conditions of the decoupling system and malfunctions could occur resulting in a hazardous situation.

In another known configuration, the breakaway coupling is arranged in line between two hoses: the hose that connects it to the dispenser and the hose that connects it to the vehicle. The advantage of this system is that it aligns itself when the hose is pulled and therefore the breakaway system functions correctly. However, the hose connecting the breakaway coupling to the dispenser is always in motion when the user is manipulating the nozzle. This leads to wear on a second hose.

### SUMMARY OF THE INVENTION

An aim of the present invention is to overcome all or some of the aforementioned disadvantages of the prior art.

To this end, the station according to the invention, which otherwise conforms to the generic definition provided in the preamble above, is essentially characterized in that the guide member comprises an assembly of deflector wall(s) converging toward a central passage zone ensuring the localized retention of the hose portion, the portion of circuit located between the breakaway coupling and the guide member being oriented at least substantially along the working axis of the breakaway coupling, the assembly of deflector wall(s) of the guide member being further configured to transfer, along the working axis of the breakaway coupling, at least part of the tensile forces on the hose portion that are oriented transversely to the working axis of the breakaway coupling.

This provides a breakaway coupling that may be housed in a rigid and fixed manner in a station 1 dispenser. In addition, any pulling-off of the hose is always in the working axis of the breakaway coupling, regardless of the direction of departure of a vehicle (forwards or backwards) without disconnecting first and regardless of the filling side (left or right) of a vehicle.

Furthermore, embodiments of the invention may comprise one or more of the following features:
the assembly of deflector wall(s) comprises one or more curved walls with a radius of curvature between 5 mm and 300 mm;
the assembly of deflector wall(s) comprises at least one fixed wall;
the assembly of deflector wall(s) comprises at least one movable wall, in particular a roller mounted on a moveable axis and rotating thereon;
the assembly of deflector wall(s) comprises at least two vertically oriented lateral walls forming lateral stops on either side of the hose portion;
the assembly of deflector wall(s) comprises at least one of the following: an upper wall oriented horizontally and forming a vertical stop above the hose portion, a lower wall oriented horizontally and forming a vertical stop below the hose portion;
the breakaway coupling is arranged in the housing with an orientation parallel or substantially parallel to the working axis;
the breakaway coupling is arranged in the housing at a height comprised between 5 cm and 3 m and preferably between 50 cm and 1 m from the ground;
the gas source contains a fuel gas comprising or consisting of hydrogen in liquid and/or gaseous form.

The invention may also relate to any alternative device or process comprising any combination of the features above or below within the scope of the claims.

### BRIEF DESCRIPTION OF THE FIGURES

Further particular features and advantages will become apparent upon reading the description hereinafter, which is provided with reference to the figures, in which:

FIG. 1 represents schematically a partial side view illustrating an embodiment of a structure of a station according to the invention;

FIG. 2 represents schematically a partial view in vertical cross section illustrating an embodiment of a detail of the station according to the invention;

FIG. 3 represents schematically a partial perspective view illustrating an embodiment of a detail of a guide member of FIG. 2;

FIG. 4 represents schematically a partial perspective view illustrating an embodiment of a structure of a station according to the invention;

FIG. 5 represents schematically a partial perspective view illustrating another embodiment of a part of a station according to the invention.

### DETAILED DESCRIPTION OF THE INVENTION

The illustrated gas tank filling station 1 comprises a gas source 2, a circuit 3 comprising an upstream end 4 connected to the source 2 and a downstream end 5 comprising a hose portion, the end of which is intended to be connected to the tank(s) 6 to be filled (e.g. via a nozzle).

The circuit 3 further comprises, between the source 2 and the downstream end 5, an automatic shut-off breakaway coupling 7 mounted along a working axis. This breakaway coupling 7 is configured to automatically shut off the circuit 3 (and separate the circuit into two parts if necessary) in the event of a determined tensile force on the breakaway coupling 7 along its working axis.

The station 1 comprises a dispenser housing 8, the breakaway coupling 7 being arranged (e.g. fixed) in the dispenser housing 8 with a determined orientation of the working axis, e.g. horizontal in the example shown.

At least part of the hose portion of the downstream end 5 of the circuit protrudes from the dispenser housing 8. In addition, the dispenser housing 8 comprises a guide member 9 for guiding a zone of the hose portion.

The guide member 9 comprises an assembly of deflecting wall(s) 10 converging toward a central zone of passage of the hose and ensuring the localized retention of the hose portion. The guide member 9 keeps the portion of circuit 3 that is located between the breakaway coupling 7 and the guide member 9 at least substantially along the working axis of the breakaway coupling 7 (i.e., substantially horizontal in this embodiment, the term “substantially” meaning, for example, that a slight angle of zero to thirty degrees and preferably zero to ten degrees relative to the working axis may be possible).

The assembly of deflecting wall(s) 10 of the guide member 9 is further configured to transfer, along the working axis of the breakaway coupling 7, at least part of the tensile forces exerted on the hose portion that are oriented transversely to the working axis of the breakaway coupling 7. That is to say that, in the event of tensile force on the downstream end of the circuit (vehicle leaving without first disconnecting), even if the hose forms a large angle A with the working axis of the breakaway coupling 7, the guide member 9 forms a deflection system, preferably multi-directional, which transfers the forces onto the working axis of the breakaway coupling 7 and, in particular, allows the hose to escape the corners of the dispenser housing 8. That is to say that, preferably the hose portion rests solely on the assembly of wall(s) of the guide member 9 regardless of the orientation of the downstream part of the hose portion. For example, the guide member 9 may protrude from the face of the dispenser housing 8 onto which the guide member 9 opens.

The safety of the station 1 is thus improved. In effect, when the vehicle moves off forwards or backwards, the deflection system allows the forces to be passed on to the working axis of the breakaway coupling 7. The station 1 is also more flexible, as the system allows vehicles access in both directions, something which it is currently not possible to do safely with the existing facilities.

For example, the assembly of deflecting wall(s) 10 comprises one or more curved walls having a radius of curvature between 5 mm and 300 mm, for example (without this range being limiting). For example, the assembly of deflecting wall(s) 10 forms a converging tube or part of a tube (radius of curvature decreasing towards the upstream end).

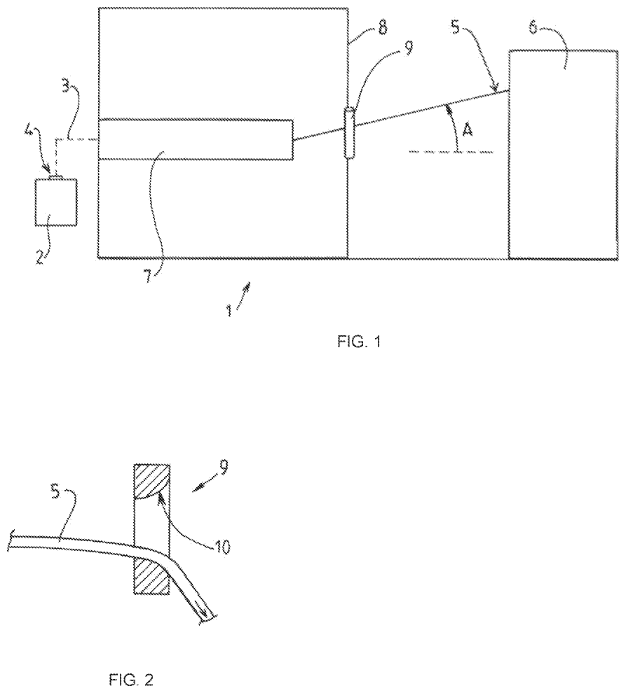

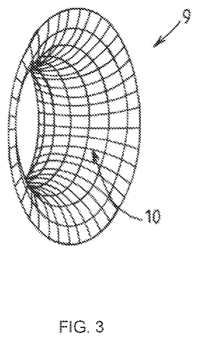

As illustrated in FIG. 2 and FIG. 3, the assembly of deflector wall(s) 10 may comprise a torus section (or an entire torus).

The assembly of deflector wall(s) 10 comprises, for example, at least one fixed wall.

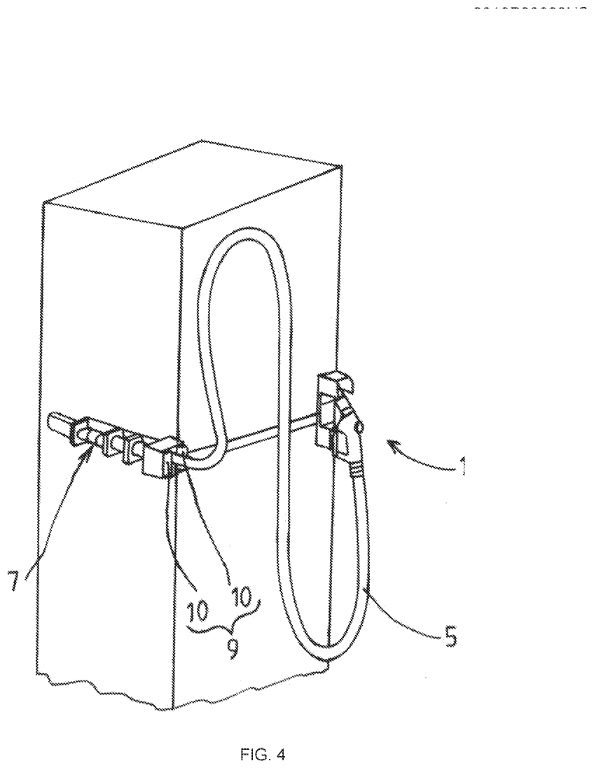

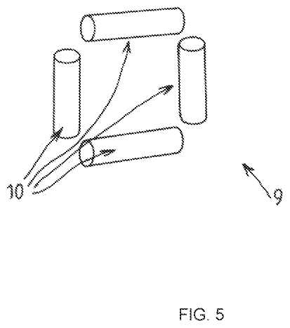

Alternatively, or in combination therewith, the assembly of deflecting wall(s) 10 may comprise at least one movable wall, for example a roller mounted on an axis (movable or fixed) and rotating about this axis. As illustrated in FIG. 4, the guide member 9 may comprise two vertically oriented lateral deflector walls 10 forming lateral stops on either side of the hose portion, the two lateral walls 10 may each be formed of a roller rotatable about a vertical axis.

As illustrated in FIG. 5, the assembly of deflector wall(s) 10 may comprise an upper wall oriented horizontally (notably a roller rotatable about a horizontal axis) and forming a vertical stop above the hose portion and/or a lower wall oriented horizontally (notably a roller rotatable about a horizontal axis) and forming a vertical stop below the hose portion.

This configuration makes it possible to transfer on to the working axis of the breakaway coupling 7 the horizontal tensile forces on the hose on the two opposite sides, as well as the upward or downward tensile forces on the hose. This allows the transfer of the vertical and horizontal components of the tensile forces.

Naturally, the working axis of the breakaway coupling 7 is not necessarily horizontal.

Furthermore, this breakaway coupling 7 and the guide member 9 could be arranged at any height.

Preferably, this breakaway coupling 7 and the guide member 9 are fixed at the usual coupling height for coupling the hose end to the tanks (at the average height of the tank inlet/outlet, e.g. about one metre).

In the case where the breakaway coupling 7 is fixed at the height of the inlet of the tank to be filled, the horizontal walls 10 or rollers transferring the vertical components of the forces are optional. The guidance system may therefore be further simplified.

Since the length of the hose is usually several metres, the height of the system relative to the average height of the tanks may vary by several tens of centimetres without compromising the operation. The maximum inclination angle of the hose at the outlet of the deflection system thus remains below the value recommended by the manufacturer of the breakaway coupling 7 and within the useful height of the guide member 9.

The invention allows for the number of parts required to be reduced (only one guiding/deflecting direction if required or, in the case of the torus, only one guide element). Such a structure therefore allows the structure and the assembly to be simplified, as well as allowing the effectiveness of the security system to be improved, while being less expensive.

In particular, if the guide member 9 comprises a torus or half-torus, this provides flexibility regarding the shape of the dispenser housing 8 and the location of the assembly of the breakaway coupling 7 and guide member 9.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A station for filling gas tanks comprising: a dispenser housing, a gas source and a circuit, the circuit comprising an upstream end connected to the source, a downstream end comprising a hose portion, and an automatic shut-off breakaway coupling disposed between the source and the downstream end and which is arranged along a working axis, wherein:
a downstream end of the hose portion is intended to be connected to the tank(s) to be filled;
said breakaway coupling ensures an automatic shut-off of the circuit if a determined tensile force is applied on said breakaway coupling along its working axis;
the breakaway coupling is arranged in the dispenser housing with a determined orientation of the working axis;
at least one part of the hose portion of the downstream end of the circuit protrudes from the dispenser housing;
the dispenser housing comprises a guide member for guiding a zone of the hose portion;
the guide member comprises an assembly deflecting wall(s) converging toward a central passage zone ensuring a localized retention of the hose portion;
the portion of circuit located between the breakaway coupling and the guide member is oriented at least substantially along the working axis of the breakaway coupling; and
the assembly of deflecting wall(s) of the guide member is further configured to transfer, along the working axis of the breakaway coupling, at least part of the tensile forces on the hose portion that are oriented transversely with respect to the working axis of the breakaway coupling.

2. The station of claim 1, wherein the assembly of deflecting wall(s) comprises one or more curved walls having a radius of curvature between 5 mm and 300 mm.

3. The station of claim 1, wherein the assembly of deflecting wall(s) comprises at least one fixed wall.

4. The station of claim 1, wherein the assembly of deflecting wall(s) comprises at least one movable wall.

5. The station of claim 4, wherein the at least one movable wall comprises a roller mounted on a moveable axis and rotating thereon.

6. The station of claim 1, wherein the assembly of deflecting wall(s) comprises at least two vertically oriented lateral walls forming lateral stops on each side of the hose portion.

7. The station of claim 1, wherein the assembly of deflecting wall(s) comprises at least one of the following:
an upper wall oriented horizontally and forming a vertical stop above the hose portion; and
a lower wall oriented horizontally and forming a vertical stop below the hose portion.

8. The station of claim 1, wherein the breakaway coupling is arranged in the housing with an orientation parallel to or substantially parallel to the working axis.

9. The station of claim 1, wherein the breakaway coupling is arranged in the housing at a height between 5 cm and 3 m from the ground.

10. The station of claim 1, wherein the breakaway coupling is arranged in the housing at a height between 50 cm and 1 m from the ground.

11. The station of claim 1, wherein the gas source contains a fuel gas comprising hydrogen in liquid and/or gaseous form.

12. The station of claim 1, wherein the gas source contains a fuel gas essentially consisting of hydrogen in liquid and/or gaseous form.
